(19) United States
(12) Patent Application Publication
(10) Pub. No.: US 2011/0076068 A1
(43) Pub. Date: Mar. 31, 2011

(54) FIXING DEVICE, IMAGE FORMING APPARATUS, AND METHOD OF REMOVING RESIDUAL TONER

(75) Inventor: Hiroyuki Kunugi, Shizuoka (JP)

(73) Assignees: Kabushiki Kaisha Toshiba, Tokyo (JP); Toshiba Tec Kabushiki Kaisha, Tokyo (JP)

(21) Appl. No.: 12/891,534

(22) Filed: Sep. 27, 2010

Related U.S. Application Data
(60) Provisional application No. 61/246,646, filed on Sep. 29, 2009.

(51) Int. Cl. G03G 15/20

(52) U.S. Cl. 399/323

(57) ABSTRACT

A fixing device includes: a heating belt configured to heat a toner to be transferred onto a sheet; a heater for heating the heating belt; a peeling blade for peeling off the sheet adhering to the heating belt; and a driving unit configured to drive the peeling blade between a contact position where the driving unit brings the peeling blade into contact with the heating belt and a separated position where the driving unit separates the peeling blade from the heating belt. The peeling blade is located in the contact position until the heating belt rotates at least once.

### CROSS-REFERENCE TO RELATED APPLICATION

This application is also based upon and claims the benefit of priority from U.S. provisional application 61/246,646, filed on Sep. 29, 2009; the entire contents of which are incorporated herein by reference.

### FIELD

Embodiments described herein relate generally to a technique for removing a toner remaining on a rotating member configured to heat the toner to be transferred onto a sheet.

### BACKGROUND

In an image forming apparatus in the past, when a jam occurs, a heater for heating a fixing roller stops operation. When the heater stops the operation, the temperature of a sheet conveyed by the fixing roller gradually falls. When the temperature of the sheet falls, in some case, a toner transferred onto the sheet adheres to the fixing roller without being fixed on the sheet.

When printing is performed after jam treatment, it is likely that the residual toner adhering to the fixing roller is transferred onto the sheet and image quality is deteriorated.

### DESCRIPTION OF THE DRAWINGS

FIG. 1 is a longitudinal sectional view of an image forming apparatus;

FIG. 2 is a block diagram of a driving unit;

FIG. 3 is an enlarged view of a fixing device, wherein a state before a peeling blade comes into contact with a heating belt is shown;

FIG. 4 is an enlarged view of the fixing device, wherein a state in which the peeling blade comes into contact with the heating belt is shown;

FIG. 5 is a flowchart for explaining a method of removing a residual toner; and

FIG. 6 is a sectional view of a peeling blade in a first modification.

### DETAILED DESCRIPTION

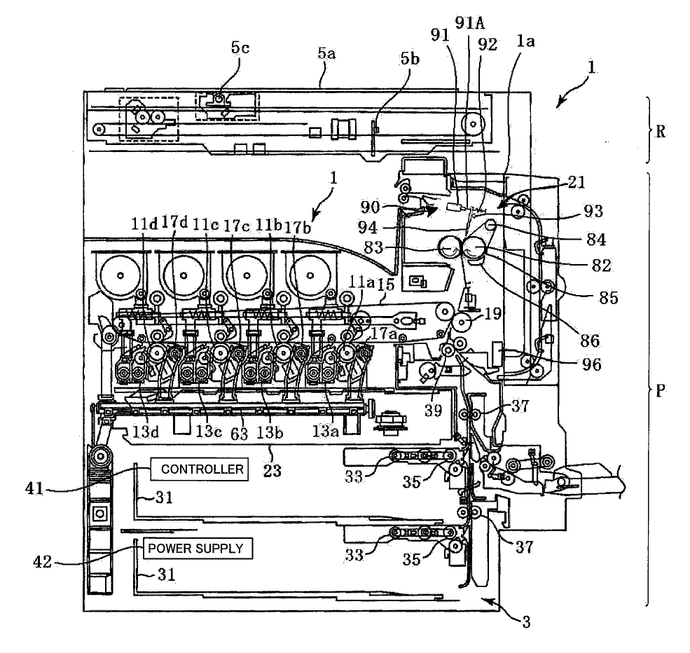

FIG. 1 is a longitudinal sectional view of an image forming apparatus. An image forming apparatus 1 includes an image reading unit R and an image forming unit P. A controller 41 manages control of the entire image forming apparatus 1 including the image reading unit R and the image forming unit P.

The image reading unit R scans and reads images of a sheet document and a book document.

The image reading unit R includes a document table 5a configured to support an original document and an image sensor 5b configured to convert image information into image data. The image sensor 5b may be a CCD sensor. The image reading unit R irradiates illumination light, which is emitted from a lighting device 5c, on an original document set on the document table 5a and converts, with the image sensor 5b, reflected light reflected on the original document into an image signal.

The image forming unit P forms a developer image on a sheet on the basis of, for example, an image read from the original document by the image reading unit R or image data transmitted from an external apparatus to the image forming apparatus 1.

The image forming unit P includes a sheet feeding unit 3, photoconductive drums 11a to 11d, developing devices 13a to 13d, a transfer belt 15, cleaners 17a to 17d, a transfer device 19, a fixing device 21, and an exposure device 23.

The photoconductive drums 11a to 11d carry latent images. The developing devices 13a to 13d supply toners to the latent images carried by the photoconductive drums 11a to 11d corresponding thereto and develop the latent images. The transfer belt 15 carries, in order, images of the toners carried by the photoconductive drums 11a to 11d.

The cleaners 17a to 17d remove the toners remaining on the photoconductive drums 11a to lid corresponding thereto. The transfer device 19 transfers the images of the toners carried by the transfer belt 15 onto a sheet. The sheet may be plain paper or an OHP sheet that is a transparent resin sheet.

The exposure device 23 forms the latent images on the photoconductive drums 11a to 11d. The fixing device 21 heats the sheet to thereby fix the toner images transferred onto the sheet. Details of the fixing device 21 are explained later.

The sheet feeding unit 3 includes cassettes 31, pickup rollers 33, separating mechanisms 35, conveying rollers 37, and an aligning roller 39. The separating mechanisms 35 prevent two or more sheets from being extracted from the cassettes 31 by the pickup rollers 33 at a time. The conveying rollers 37 convey sheets separated by the separating mechanisms 35 to the aligning roller 39 one by one.

The aligning roller 39 feeds the sheet to a transfer position, where the transfer device 19 and the transfer belt 15 are in contact with each other, to be timed to coincide with the transfer of the images of the toners from the transfer belt 15 onto the sheet by the transfer device 19.

A cover 1a moves between a closed position where the cover 1a closes an area for performing jam treatment and an opened position where the cover 1a projects from the image forming apparatus 1 and opens the area for performing the jam treatment.

An opening and closing sensor 96 detects opening and closing of the cover 1a. The opening and closing sensor 96 may be a switch of a push button type. When the cover 1a moves from the opened position to the closed position, the opening and closing sensor 96 outputs a signal.

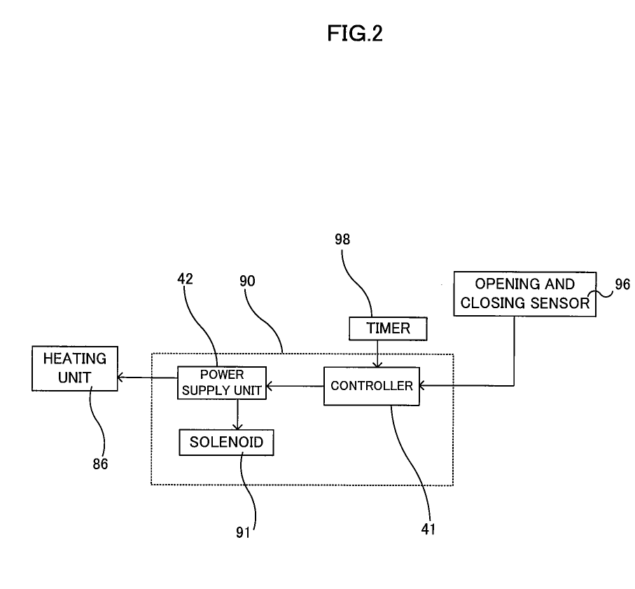

The fixing device 21 is explained in detail below with reference to FIGS. 1 and 2. FIG. 2 is a block diagram of a driving unit.

The fixing device 21 includes a heating roller 82, a pressing roller 83, a stretching and suspending roller 84, a heating belt 85 as a rotating member, a heater 86, a peeling blade 94, and a driving unit 90.

The pressing roller 83 comes into contact with the heating belt 85 and rotates in an arrow direction. The heating roller 82, the stretching and suspending roller 84, and the heating belt 85 rotate following the pressing roller 83.

The heater 86 includes a coil. A magnetic flux is generated by high-frequency current applied to the coil. The magnetic flux generated by the heater 86 induces eddy-current in the heating belt 85. The heating belt 85 generates heat.

The peeling blade 94 extends in a direction in which the heating belt 85 is located. The peeling blade 94 comes into contact with a sheet discharged from a nip position between the pressing roller 83 and the heating belt 85 and adhering to the heating belt 85. The peeling blade 94 peels off the sheet, with which the peeling blade 94 comes into contact, from the heating belt 85.

The driving unit 90 moves between a separated position where the driving unit 90 separates the peeling blade 94 from the heating belt 85 and a contact position where the driving unit 90 brings the peeling blade 94 into contact with the heating belt 85.

The driving unit 90 includes a solenoid 91, a return spring 92, and a swinging shaft section 93. The solenoid 91 includes a movable core 91A. The controller 41 controls a power supply unit 42 to thereby control electric current flowing to a coil of the solenoid 91 to be turned on and off.

The controller 41 is connected to a timer 98 and performs various kinds of control on the basis of a count time of the timer 98.

A distal end portion of the movable core 91A is connected to a proximal end portion of the peeling blade 94. The return spring 92 is located on the opposite side of the movable core 91A across the peeling blade 94. A distal end portion of the return spring 92 is connected to the proximal end portion of the peeling blade 94.

The swinging shaft section 93 is located further on a distal end side of the peeling blade 94 than the return spring 92. The peeling blade 94 swings around the swinging shaft section 93.

The peeling blade 94 may be lubricated rubber. When the peeling blade 94 comes into contact with the heating belt 85, a load applied to the heating belt 85 is small and deterioration in image quality is suppressed.

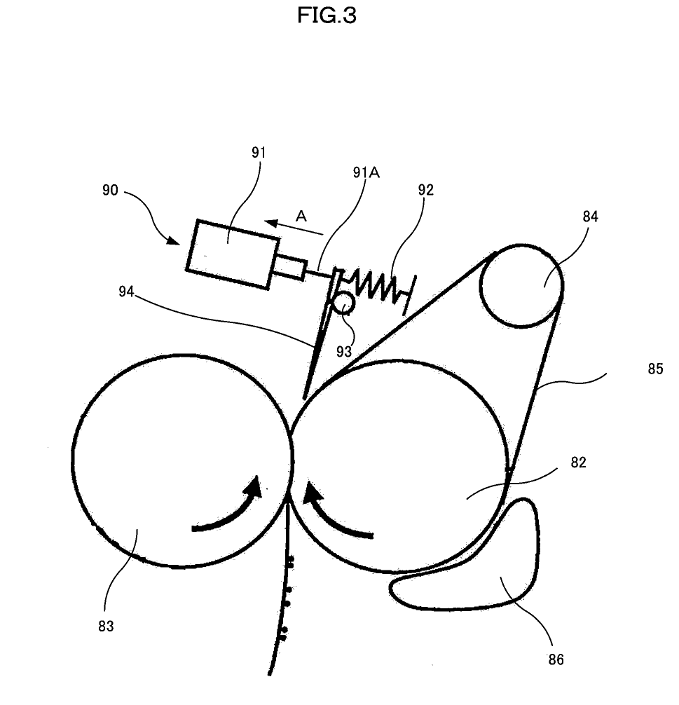

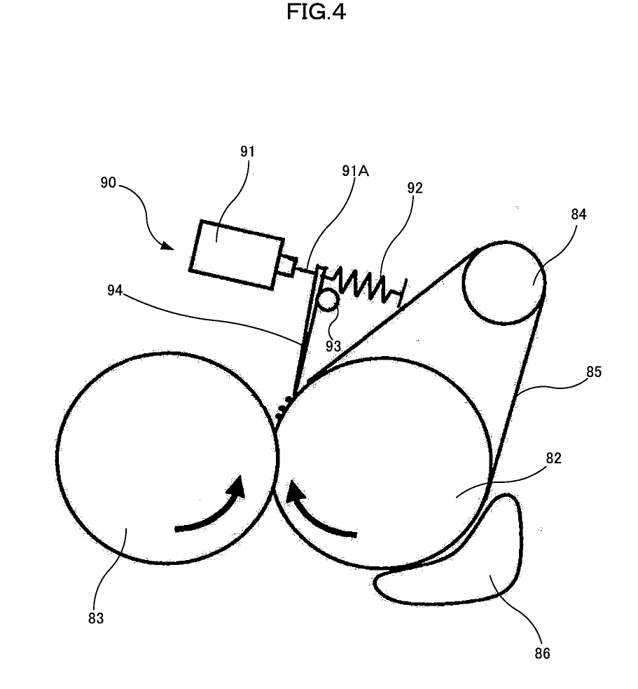

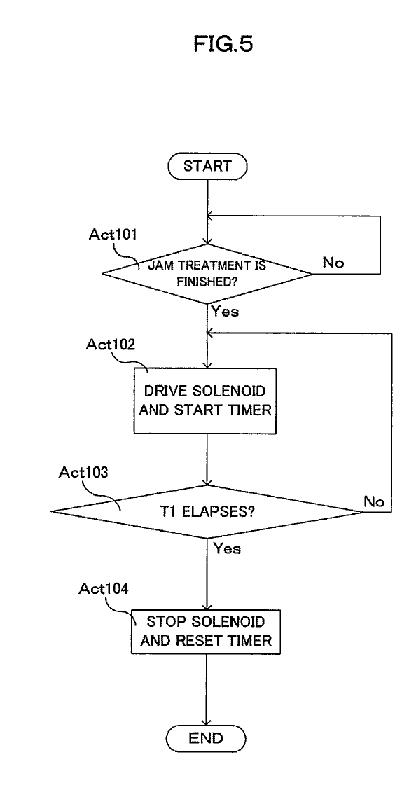

A method of removing a residual toner adhering to the heating belt 85 is explained with reference to FIGS. 3 to 5. FIG. 3 is an enlarged view of the fixing device, wherein a state before the peeling blade comes into contact with the heating belt is shown. FIG. 4 is an enlarged view of the fixing device, wherein a state in which the peeling blade comes into contact with the heating belt is shown. FIG. 5 is a flowchart for explaining the method of removing a residual toner.

It is assumed that, in an initial state, the cover 1a is located in the opened position and jam treatment is being performed. As shown in FIG. 3, the peeling blade 94 is located in a position apart from the heating belt 85.

In Act 101, the controller 41 discriminates presence or absence of an output from the opening and closing sensor 96. If an output from the opening and closing sensor 96 is present, the controller 41 proceeds to Act 102.

In Act 102, the controller 41 instructs the power supply unit 42 to energize the solenoid 91 and instructs the timer 98 to count time.

When electric current flows to the solenoid 91, the movable core 91A linearly moves in an arrow A direction in FIG. 3. When the movable core 91A moves in the arrow A direction, the peeling blade 94 swings in the counterclockwise direction with the swinging shaft section 93 as a rotation axis.

When the peeling blade 94 further swings in the counterclockwise direction, as shown in FIG. 4, a distal end portion of the peeling blade 94 comes into contact with the heating belt 85.

The peeling blade 94 may come into contact with the heating belt 85 in an area where the heating roller 82 and the heating belt 85 overlap.

When the peeling blade 94 swings in the counterclockwise direction, the return spring 92 stretches. The peeling blade 94 swings in the counterclockwise direction while being pulled by the return spring 92 in the clockwise direction with the swinging shaft section 93 as the rotation axis.

In Act 103, the controller 41 discriminates whether the time counted by the timer 98 reaches T1. When time required by the heating belt 85 to rotate once is represented as T2, T1 may be equal to or longer than T2.

In a state in which the peeling blade 94 is in contact with the heating belt 85, the heating belt 85 rotates at least once, whereby a residual toner remaining on the heating belt 85 moves to the peeling blade 94.

When the heating belt 85 rotates, the controller 41 may control the power supply unit 42 and energize the heater 86. Timing of temperature rising processing for the heating belt 85, the temperature of which falls during the jam treatment, and timing of removal processing for the residual toner adhering to the heating belt 85 are the same. Therefore, a preparation time for printing is reduced.

If the time counted by the timer 98 reaches T1 in Act 103, the controller 41 proceeds to Act 104.

In Act 104, the controller 41 instructs the power supply unit 42 to inhibit the energization to the solenoid 91. When the electric current stops flowing to the solenoid 91, with spring force of the return spring 92, the peeling blade 94 swings in the clockwise direction with the swinging shaft section 93 as the rotation axis. When the peeling blade 94 further swings, the peeling blade 94 returns to the separated position shown in FIG. 3.

In Act 104, the controller 41 resets the timer 98.

### First Modification

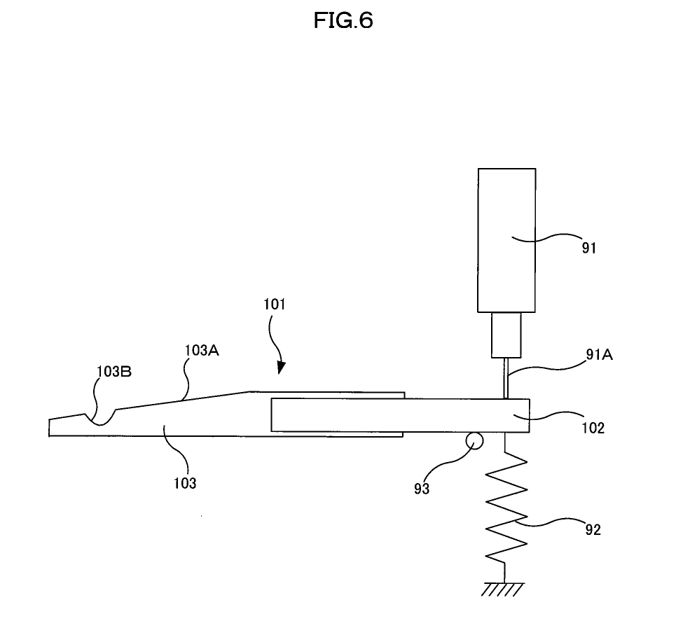

FIG. 6 is a sectional view of a peeling blade in a first modification. Components having functions same as those in the embodiment are denoted by the same reference numerals and signs. The peeling blade 101 includes a substrate 102 and a contact section 103. The substrate 102 may be SUS.

The return spring 92 is connected to one end face in the thickness direction of the substrate 102. The movable core 91A is connected to the other end face. The contact section 103 covers a front end side of the substrate 102. The contact section 103 may be lubricated rubber. The lubricated rubber may be fluorine resin.

The contact section 103 includes a taper section 103A, the thickness of which gradually decreases from a rear end portion to a front end portion thereof. The taper section 103A of the contact section 103 includes a storage opening 103B. The storage opening 103B stores a residual toner moved from the heating belt 85 to the peeling blade 101. The storage opening 103B prevents the residual toner once moved to the peeling blade 101 from falling.

### Second Modification

The driving unit 90 is not limited to the solenoid 91 and may be another driving mechanism. The other driving mechanism may be a link mechanism or an air cylinder.

The peeling blade 94 is fixed to the link mechanism. The link mechanism rotates, whereby the peeling blade 94 operates.

The peeling blade 94 is fixed to a distal end portion of a piston rod of the air cylinder. The piston rod moves back and forth, whereby the peeling blade 94 operates.

The peeling blade 94 and the movable core 91A may be located on the same axis. The peeling blade 94 may be fixed to the distal end portion of the movable core 91A. When the movable core 91A moves in a direction away from the solenoid 91, the peeling blade 94 comes into contact with the heating belt 85. When the movable core 91A moves in a direction approaching the solenoid 91, the peeling blade 94 separates from the heating belt 85.

### Third Modification

Timing when the peeling blade 94 operates may be timing other than timing immediately after the jam treatment.

The timing when the peeling blade 94 operates may be timing when image density detected by pixel count exceeds a threshold. For example, in the case of color printing, plural kinds of toners are stacked on a sheet. Therefore, the image density rises and the toners tend to adhere to the heating belt 85. The toners adhering to the heating belt 85 during the color printing move to the peeling blade 94.

### Fourth Modification

The heating roller 82 and the heating belt 85 may be replaced with a heat generating roll. The heat generating roll includes, in a surface layer section, a conductive layer in which eddy-current is generated by a magnetic flux from the heater 86. The peeling blade 94 moves between a contact position where the peeling blade 94 comes in to contact with the heat generating roll and a separated position where the peeling blade 94 separates from the heating roll.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the sprit of the inventions. The accompanying claims and their equivalents are intended to cover such forms or modifications as would fall within the scope and spirit of the inventions.

1. A fixing device comprising:
a rotating member configured to heat a toner to be transferred onto a sheet;
a heater configured to heat the rotating member;
a peeling blade configured to peeling off the sheet adhering to the rotating member; and
a driving unit configured to drive the peeling blade between a first position where the driving unit brings the peeling blade into contact with the rotating member and a second position where the driving unit separates the peeling blade from the rotating member.

2. The device according to claim 1, wherein the peeling blade is located in the second position until the rotating member rotates at least once.

3. The device according to claim 1, wherein the peeling blade includes an opening that stores the toner removed from the rotating member in the second position.

4. The device according to claim 1, wherein the peeling blade is lubricated rubber.

5. The device according to claim 1, wherein the driving unit includes:
a swinging shaft around which the peeling blade swings;
a solenoid including a movable core connected to the peeling blade, the solenoid swinging the peeling blade between the first position and the second position according to movement of the movable core; and
a controller configured to control energization to the solenoid.

6. The device according to claim 5, wherein, when the controller permits the energization to the solenoid, the peeling blade moves from the second position to the first position and, when the controller inhibits the energization to the solenoid, the peeling blade moves from the first position to the second position.

7. The device according to claim 6, further comprising an urging unit configured to urge, in a state in which the peeling blade is located in the first position, the peeling blade in a direction in which the peeling blade swings to the second position.

8. The device according to claim 1, wherein the rotating member is a belt member.

9. An image forming apparatus comprising:
a sheet conveying unit configured to convey a sheet;
a transfer unit configured to transfer a toner image onto the sheet; and
a fixing unit including:
a rotating member configured to heat a toner to be transferred onto the sheet;
a heater configured to heat the rotating member;
a peeling blade configured to peel off the sheet adhering to the rotating member; and
a driving unit configured to drive the peeling blade between a first position where the driving unit brings the peeling blade into contact with the rotating member and a second position where the driving unit separates the peeling blade from the rotating member.

10. The apparatus according to claim 9, wherein the peeling blade is located in the second position until the rotating member rotates at least once.

11. The apparatus according to claim 9, wherein the peeling blade includes an opening that stores the toner removed from the rotating member in the second position.

12. The apparatus according to claim 9, wherein the peeling blade is lubricated rubber.

13. The apparatus according to claim 9, wherein the driving unit includes:
a swinging shaft around which the peeling blade swings;
a solenoid including a movable core connected to the peeling blade, the solenoid to swing the peeling blade between the first position and the second position according to movement of the movable core; and
a controller configured to control energization to the solenoid.

14. The apparatus according to claim 13, wherein, when the controller permits the energization to the solenoid, the peeling blade moves from the second position to the first position and, when the controller inhibits the energization to the solenoid, the peeling blade moves from the first position to the second position.

15. The apparatus according to claim 14, further comprising an urging unit configured to urge, in a state in which the peeling blade is located in the first position, the peeling blade in a direction in which the peeling blade swings to the second position.

16. The apparatus according to claim 9, wherein the rotating member is a belt member.

17. The apparatus according to claim 9, wherein the peeling blade moves from the second position to the first position to be timed to coincide with operation of the heater after jam treatment.

18. A method of removing a residual toner comprising a peeling blade for peeling off a sheet adhering to a rotating member, which heats a toner to be transferred onto a sheet, coming into contact with the rotating member to thereby remove the residual toner adhering to the rotating member.

19. The method according to claim 18, wherein the peeling blade is in contact with the rotating member until the rotating member rotates at least once.

20. The method according to claim 18, wherein the peeling blade has an opening that stores the toner removed from the rotating member.
